(19) United States
(12) Patent Application Publication
(10) Pub. No.: US 2016/0025520 A1
(43) Pub. Date: Jan. 28, 2016

(54) CAPACITIVE TRIM SENSOR AND SYSTEM

(71) Applicant: MAGNA CLOSURES INC., Newmarket (CA)

(72) Inventors: Mirko PRIBISIC, North York (CA); Timothy DeZORZI, South Lyon, MI (US); Liviu BOLBOCIANU, North York (CA); Thomas Andrew MELLARY, East Gwillimbury (CA); Allan CORNER, Aurora (CA); Erik SCHATTENMANN, Toronto (CA); Anjan NAYANI, North York (CA)

(21) Appl. No.: 14/776,050

(22) PCT Filed: Mar. 17, 2014
(86) PCT No.: PCT/IB2014/001107

§ 371 Date: Sep. 14, 2015

Related U.S. Application Data
(60) Provisional application No. 61/791,322, filed on Mar. 15, 2013.

(51) Int. Cl. G01D 5/24; B62D 33/027

(52) U.S. Cl. CPC G01D 5/24; B62D 33/027

(57) ABSTRACT

A capacitive sensing system for a liftgate of a vehicle includes at least one elongate capacitive sensor mounted on a trim panel of the liftgate. The at least one elongate capacitive sensor is arranged to extend over an area of the trim panel. The capacitive sensing system also includes a controller coupled to the at least one elongate capacitive sensor for monitoring changes in a capacitance value of the at least one elongate capacitive sensor, with the capacitance value changing when an obstacle approaches the area.

### CROSS-REFERENCE TO RELATED APPLICATION

The subject PCT patent application claims priority to U.S. provisional patent application Ser. No. 61/791,322 filed on Mar. 15, 2013 directed to a “Capacitive Trim Sensor and System”, the entire disclosure of which is incorporated herein by reference.

### FIELD OF THE INVENTION

This invention relates to the field of capacitive sensors, and more specifically, to a capacitive sensor and system for use in vehicles and other devices.

### BACKGROUND

In motor vehicles such as minivans, sport utility vehicles and the like, it has become common practice to provide the vehicle body with a large rear opening. A liftgate (also referred to as a tailgate) is typically mounted to the vehicle body or chassis with hinges for pivotal movement about a transversely extending axis between an open position and a closed position. Typically, the liftgate may be operated manually or with a power drive mechanism including a reversible electric motor.

During power operation of a vehicle liftgate, the liftgate may unexpectedly encounter an object or obstacle in its path. It is therefore desirable to cease its powered movement in that event to prevent damage to the obstacle and/or to the liftgate by impact or by pinching of the obstacle between the liftgate and vehicle body proximate the liftgate hinges.

Obstacle sensors are used in such vehicles to prevent the liftgate from closing if an obstacle (e.g., a person, etc.) is detected as the liftgate closes. Obstacle sensors come in different forms, including non-contact or proximity sensors which are typically based on capacitance changes.

Non-contact obstacle sensors typically include a metal strip or wire which is embedded in a plastic or rubber strip which is routed along and adjacent to the periphery of the litigate. The metal strip or wire and the chassis of the vehicle collectively form the two plates of a sensing capacitor. An obstacle placed between these two electrodes changes the dielectric constant and thus varies the amount of charge stored by the sensing capacitor over a given period of time. The charge stored by the sensing capacitor is transferred to a reference capacitor in order to detect the presence of the obstacle.

One problem with present non-contact sensors is that they only provide detection of obstacles within a limited area, for example, along the pinch points of the litigate.

A need therefore exists for an improved capacitive sensor and system for use in vehicles and other devices. Accordingly, a solution that addresses, at least in part, the above and other shortcomings is desired.

### SUMMARY OF THE INVENTION

According to one aspect of the invention, there is provided a capacitive sensing system for a litigate of a vehicle, comprising: at least one elongate capacitive sensor mounted on a trim panel of the litigate, the at least one elongate capacitive sensor arranged to extend over an area of the trim panel; and, a controller coupled to the at least one elongate capacitive sensor for monitoring changes in a capacitance value of the at least one elongate capacitive sensor, the capacitance value changing when an obstacle approaches the area.

### BRIEF DESCRIPTION OF THE DRAWINGS

Features and advantages of the embodiments of the present invention will become apparent from the following detailed description, taken in combination with the appended drawings, in which:

FIG. 1 is rear perspective view illustrating a capacitive sensing system for a liftgate of a vehicle in accordance with an embodiment of an aspect of the invention;

FIG. 2 is a block diagram illustrating the capacitive sensing system of FIG. 1 in accordance with an embodiment of an aspect of the invention;

FIG. 3 is a plan view illustrating the capacitive sensing system of FIG. 1 in isolation in accordance with an embodiment of an aspect of the invention;

FIG. 4 is a plan view illustrating the capacitive sensing system of FIG. 3 mounted on a trim panel in accordance with an embodiment of an aspect of the invention;

FIG. 5 is a cross sectional view illustrating a capacitive sensor in accordance with an embodiment of an aspect of the invention;

FIG. 6 is a cross sectional view illustrating the capacitive sensor of FIG. 5 installed in a mounting channel on a trim panel in accordance with an embodiment of an aspect of the invention;

FIG. 7 is rear view illustrating a capacitive sensing system for a liftgate of a vehicle combined with liftgate mounted resistive pinch sensors, in accordance with an embodiment of an aspect of the invention;

FIG. 8 is rear view illustrating a capacitive sensing system for a liftgate of a vehicle combined with liftgate mounted resistive pinch sensors and body mounted capacitive sensors, in accordance with an embodiment of an aspect of the invention;

FIG. 9 is rear view illustrating a capacitive sensing system for a liftgate of a vehicle combined with liftgate mounted resistive and capacitive sensors and multiple controllers, in accordance with an embodiment of an aspect of the invention;

FIG. 10 is rear view illustrating a capacitive sensing system for a litigate of a vehicle combined with litigate mounted resistive and capacitive sensors and dual controllers, in accordance with an embodiment of an aspect of the invention; and,

FIG. 11 is rear view illustrating a capacitive sensing system for a tailgate of a vehicle combined with litigate mounted resistive pinch and capacitive sensors, in accordance with an embodiment of an aspect of the invention.

It will be noted that throughout the appended drawings, like features are identified by like reference numerals.

### DETAILED DESCRIPTION OF THE EXEMPLARY EMBODIMENTS

In the following description, details are set forth to provide an understanding of the invention. In some instances, certain circuits, structures and techniques have not been described or shown in detail in order not to obscure the invention.

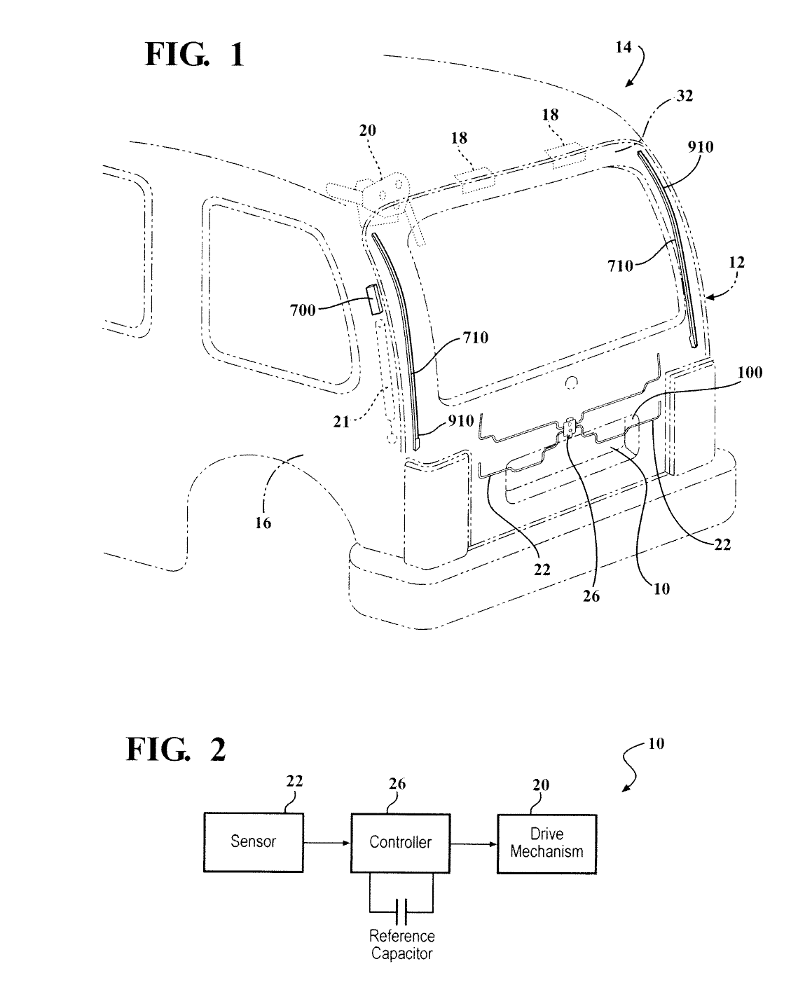

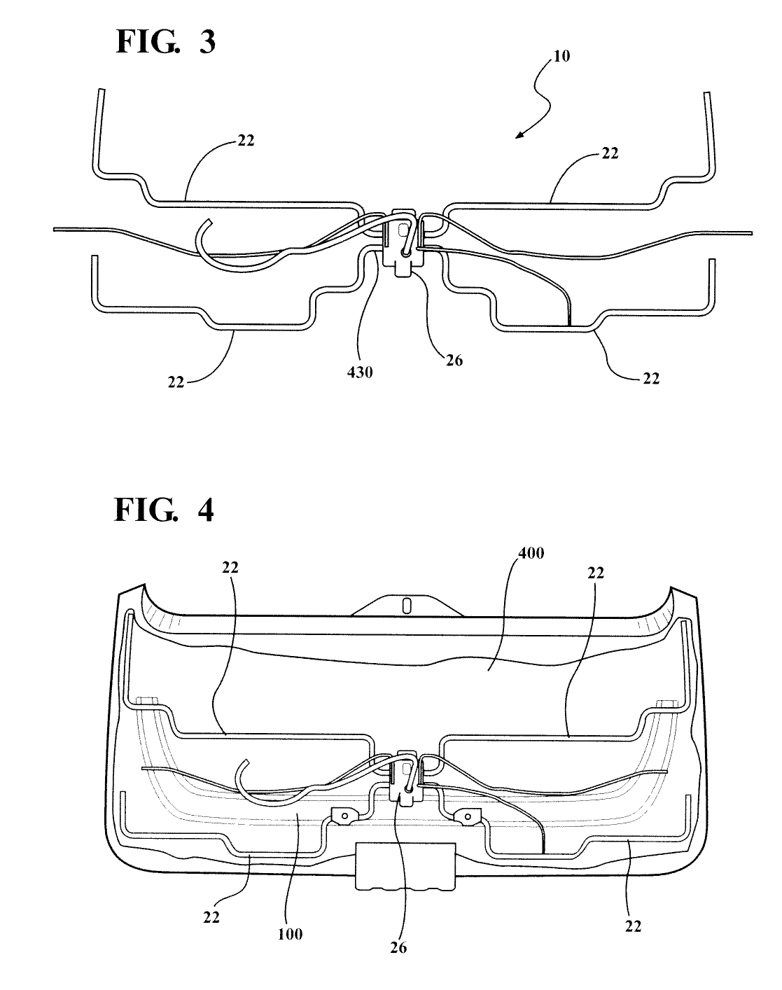

FIG. 1 is rear perspective view illustrating a capacitive sensing system 10 for a liftgate 12 of a vehicle 14 in accordance with an embodiment of an aspect of the invention. FIG. 2 is a block diagram illustrating the capacitive sensing system 10 of FIG. 1 in accordance with an embodiment of an aspect of the invention. FIG. 3 is a plan view illustrating the capacitive sensing system 10 of FIG. 1 in isolation in accordance with an embodiment of an aspect of the invention. And, FIG. 4 is a plan view illustrating the capacitive sensing system of FIG. 3 mounted on a trim panel 400 in accordance with an embodiment of an aspect of the invention.

The capacitive sensing system 10 is shown operatively associated with a closure panel 12 of a motor vehicle 14. According to one embodiment, the closure panel is a liftgate 12. It will be understood by those skilled in the art that the capacitive sensing system 10 may be used with other closure panels and windows of a vehicle or other device.

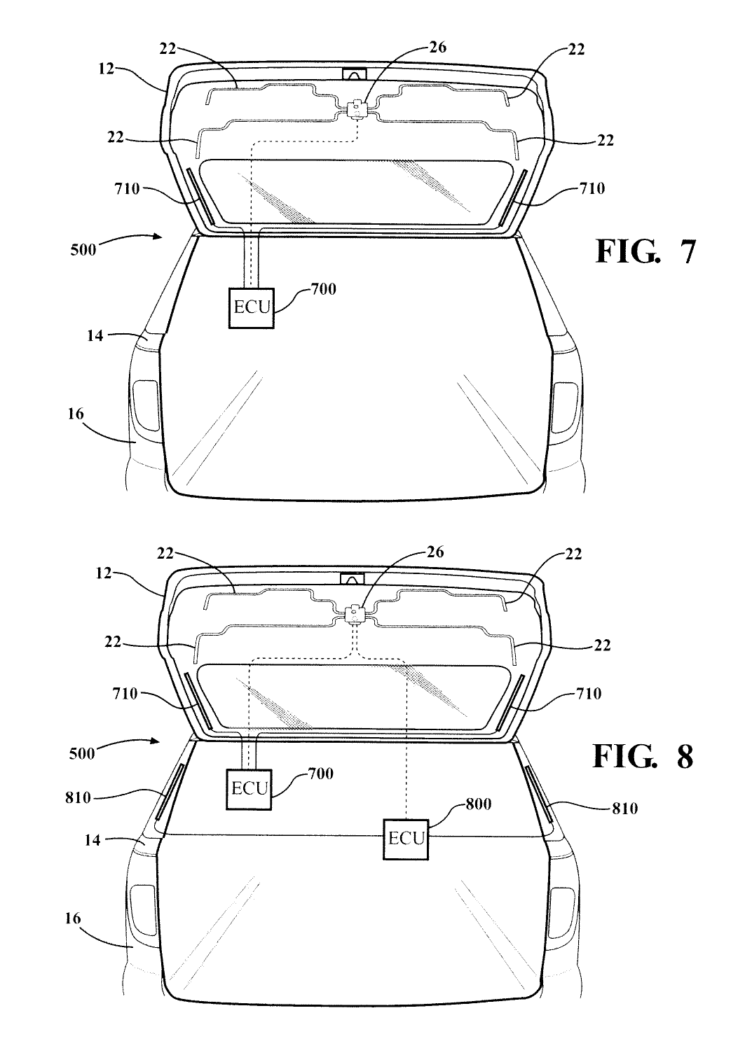

The liftgate 12 is mounted to the body 16 of the vehicle 14 through a pair of hinges 18 to pivot about a transversely extending pivot axis with respect to a large opening 500 (see FIG. 7) in the rear of the body 16. The liftgate 12 is mounted to articulate about its hinge axis between a closed position where it closes the opening 500 and an open position where it uncovers the opening 500 for free access to the vehicle body interior and assumes a slightly upwardly angled position above horizontal. The liftgate 12 is secured in its closed position by a latching mechanism (not shown). The litigate 12 is opened and closed by a drive mechanism 20 with the optional assist of a pair of gas springs 21 connected between the liftgate 12 and the body 16. The drive mechanism 20 may be similar to that described in PCT International Patent Application No. PCT/CA2012/000870, filed Sep. 20, 2012, and incorporated herein by reference. The drive mechanism 20 may be or include a powered strut as described in U.S. Pat. No. 7,938,473, issued May 20, 2011, and incorporated herein by reference.

According to one embodiment, the capacitive sensing system 10 includes four sensors 22, a mounting track or channel 24 for each of the sensors 22, and a controller 26. The sensors 22 are positioned to cover a substantial area 100 of the inner side of the liftgate 12. The sensors 22 extend outwardly from the controller 26 toward the corners of the liftgate 12. The sensors 22 are electrically coupled to an optional wire harness 430 adapted to plug into the controller 26. The controller 26 controls the drive mechanism 20 to open the liftgate 12 in the event it receives an electrical signal from one or more of the sensors 22.

According to one embodiment, each of the sensors 22 is mounted to the litigate 12 through a mounting track or channel 24. According to one embodiment, the sensors 22 are mounted in the mounting channels 24, which are in turn attached to the liftgate trim panel 400 or molded into the liftgate trim panel 400. Alternatively, it will be understood that in certain applications it may be desirable to mount the sensors 22 and their associated channels 24 on the liftgate 12 itself.

In operation, when the liftgate 12 approaches an obstacle proximate to one or more of the sensors 22 as it is articulated towards its closed position, the one or more sensors 22 are activated. The activation of a sensor 22 is detected by the controller 26. In response, the controller 26 reverses the drive mechanism 20 to articulate the liftgate 12 to its open position. Advantageously, false positive indications or noise may be reduced by using multiple sensors 22 distributed over an area 100 of the trim panel 400 as the likelihood of an obstacle activating all of the sensors 22 is not large.

The drive mechanism 20 is controlled in part by the capacitive sensing system 10. The capacitive sensing system 10 includes elongate sensors 22 that help prevent the liftgate 12 from contacting or impacting an obstacle such a person's head (not shown) that may be extending through the opening 500 when the liftgate 12 lowers towards its closed position. It will be appreciated by those skilled in the art that the capacitive sensing system 10 may be applied to any motorized or automated closure panel structure that moves between an open position and a closed position. For example, a non-exhaustive list of closure panels includes window panes, sliding doors, tailgates, sunroofs and the like. For applications such as window panes or sun roofs, the elongate sensors 22 may be mounted on the body 16 of the vehicle 14, and for applications such as powered liftgates and sliding doors the elongate sensors 22 may be mounted on the closure panel itself, e.g., within the trim panel 400 of the liftgate 12.

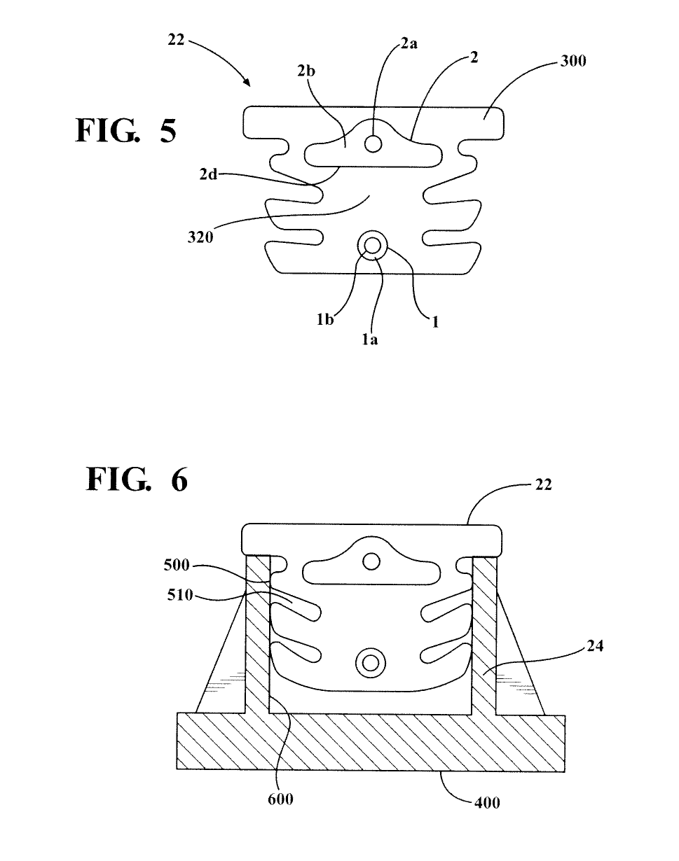

FIG. 5 is a cross sectional view illustrating a capacitive sensor 22 in accordance with an embodiment of an aspect of the invention. And, FIG. 6 is a cross sectional view illustrating the capacitive sensor 22 of FIG. 5 installed in a mounting channel 24 on a trim panel 400 in accordance with an embodiment of an aspect of the invention.

The capacitive sensor 22 is a two electrode sensor that allows for a capacitive mode of obstacle detection. In general, the two electrodes 1, 2 function in a driven shield configuration (i.e., with the upper electrode 2 being the driven shield). The case 300 positions the two electrodes 1, 2 in an arrangement that facilitates operation of the sensor 22 in a capacitive mode. The lower electrode 1 (optionally comprising a conductor la embedded in conductive resin 1b) acts as a capacitive sensor electrode, and the upper electrode 2 (optionally comprising a conductor 2a embedded in a conductive resin 2b) acts as a capacitive shield electrode. A dielectric 320 (e.g., a portion 320 of the case 300) is disposed between the capacitive shield electrode 2 and the capacitive sensor electrode 1 to isolate and maintain the distance between the two. The controller (or sensor processor (“ECU”)) 26 is in electrical communication with the electrodes 1, 2 for processing sense data received therefrom. Accordingly to one embodiment, the capacitive sensor 22 may be similar to that described in U.S. Pat. No. 6,946,853 to Gifford et al., issued Sep. 20, 2005, and incorporated herein by reference.

According to one embodiment, the capacitive sensor 22 includes an elongate non-conductive case 300 having two elongate conductive electrodes 1, 2 extending along its length. The electrodes 1, 2 are encapsulated in the case 300 and are spaced apart. When an obstacle comes between the tailgate 12 and the body 16 of vehicle 14, it effects the electric field generated by the capacitive sensor electrode 1 which results in a change in capacitance between the two electrodes 1, 2 which is indicative of the proximity of the obstacle to the liftgate 12. Hence, the two electrodes 1, 2 function as a capacitive non-contact or proximity sensor.

According to one embodiment, the capacitive sensor electrode 1 may include a first conductor la embedded in a first partially conductive body lb and the capacitive shield electrode 2 may include a second conductor 2a embedded in a second partially conductive body 2b. The conductors la, 2a may be formed from a metal wire. The partially conductive bodies 1b, 2b may be formed from a conductive resin. And, the case 300 may be formed from a non-conductive (e.g., dielectric) material (e.g., rubber, etc.). Again, the capacitive sensor electrode 1 is separated from the capacitive shield electrode 2 by a portion 320 of the case 300.

According to one embodiment, the sensor 22 is mounted on a trim panel 400 of the liftgate 12 as shown in FIGS. 4 and 6. According to one embodiment, the sensor 22 may be mounted in a channel 24 that is fastened to the trim panel 400 or that is molded into the trim panel 400. The sensor 22 may be held in the channel 24 by compressive fit. The sensor 22 may include compressive ridges 500 along the outer sides 510 of the case 300 to engage the inner sides 600 of the channel 24 to hold the sensor 22 in place within the channel 24.

According to one embodiment, the case 300 may be formed as an extruded, elongate, elastomeric trim piece with co-extruded conductive bodies lb, 2b and with the conductors 1a, 2a molded directly into the bodies 1b, 2b. The trim piece may be part of the trim panel 400 of the liftgate 12.

With respect to capacitive sensing, a portion 320 of the case 300 electrically insulates the capacitive sensor electrode 1 and the capacitive shield electrode 2 so that electrical charge can be stored therebetween in the manner of a conventional capacitor. According to one embodiment, the inner surface 2d of the capacitive shield electrode 2 may be shaped to improve the shielding function of the electrode 2. According to one embodiment, the inner surface 2d may be flat as shown in FIG. 5.

A capacitive sensor circuit may be formed by the capacitive sensor electrode 1, a terminal resistor (not shown), and the capacitive shield sensor electrode 2. The capacitive sensor circuit is coupled to and driven by the controller 26.

The sensor 22 is used by the controller 26 to measure a capacitance (or capacitance value) of an electric field extending through the opening 500 under the liftgate 12. According to one embodiment, the capacitive shield electrode 2 functions as a shielding electrode since it is positioned closer to the sheet metal of the litigate 12. As such, the electric field sensed by the capacitive sensor electrode 1 will be more readily influenced by the closer capacitive shield electrode 2 than the vehicle sheet metal. To improve signal quality, the liftgate 12 may be electrically isolated from the remainder of the vehicle 14. A powered sliding door, for example, may be isolated through the use of non-conductive rollers.

The capacitance (or capacitance value) of the sensor 22 is measured as follows. The capacitive sensor electrode 1 and the capacitive shield electrode 2 are charged by the controller 26 to the same potential using a pre-determined pulse train. For each cycle, the controller 26 transfers charge accumulated between the electrodes 1, 2 to a larger reference capacitor (see FIG. 2), and records an electrical characteristic indicative of the capacitance of the sensor 22. The electrical characteristic may be the resultant voltage of the reference capacitor where a fixed number of cycles is used to charge the electrodes 1, 2, or a cycle count (or time) where a variable number of pulses are used to charge the reference capacitor to a predetermined voltage. The average capacitance of the sensor 22 over the cycles may also be directly computed. When an obstacle enters the opening 500 under the liftgate 12, the dielectric constant between the electrodes 1, 2 will change, typically increasing the capacitance of the sensor 22 and thus affecting the recorded electrical characteristic. This increase in measured capacitance is indicative of the presence of the obstacle (i.e., its proximity to the liftgate 12).

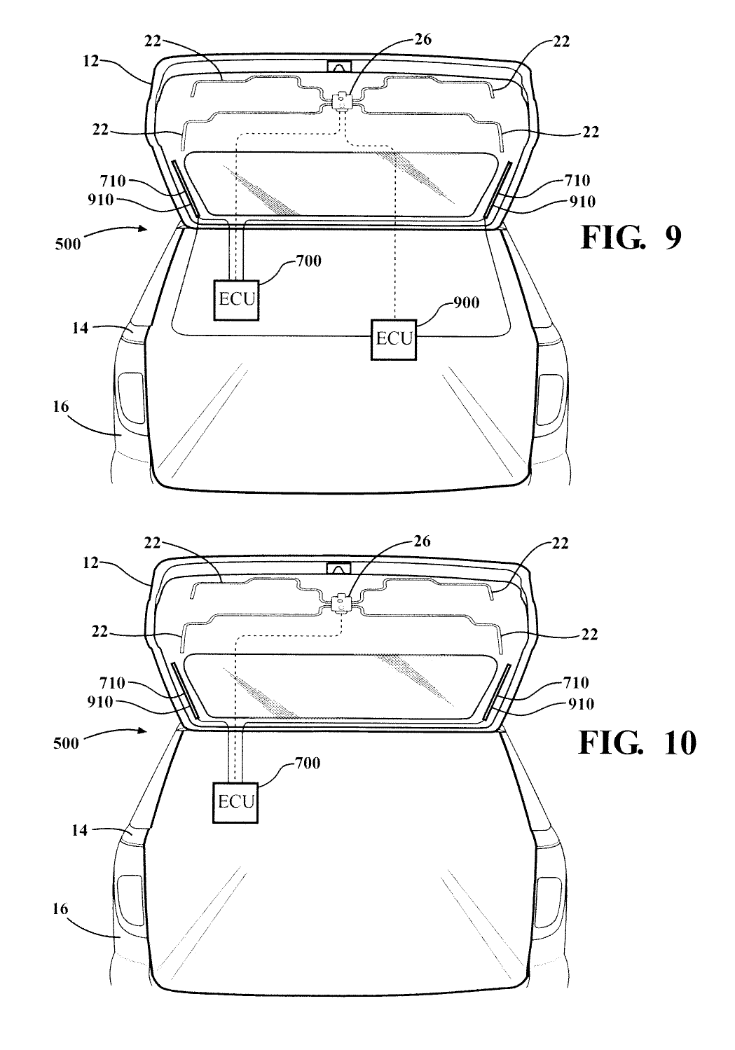

FIG. 7 is rear view illustrating a capacitive sensing system 10 for a liftgate 12 of a vehicle 14 combined with liftgate mounted resistive pinch sensors 710, in accordance with an embodiment of an aspect of the invention. FIG. 8 is rear view illustrating a capacitive sensing system 10 for a liftgate 12 of a vehicle 14 combined with liftgate mounted resistive pinch sensors 710 and body mounted capacitive sensors 810, in accordance with an embodiment of an aspect of the invention. FIG. 9 is rear view illustrating a capacitive sensing system 10 for a liftgate 12 of a vehicle 14 combined with liftgate mounted resistive and capacitive sensors 710, 910 and multiple controllers 26, 700, 900, in accordance with an embodiment of an aspect of the invention. FIG. 10 is rear view illustrating a capacitive sensing system 10 for a liftgate 12 of a vehicle 14 combined with liftgate 12 mounted resistive and capacitive sensors 710, 910 and dual controllers 26, 700, in accordance with an embodiment of an aspect of the invention. And, FIG. II is rear view illustrating a capacitive sensing system 10 for a liftgate 12 of a vehicle 14 combined with liftgate mounted resistive and capacitive sensors 710, 910, in accordance with an embodiment of an aspect of the invention.

As shown in FIGS. 7-11, the capacitive sensing system 10 may be combined with various pinch sensors and systems to provide improved obstacle and pinch sensing. In FIG. 7, the capacitive sensing system 10 is combined with a pair of resistive pinch sensors 710 disposed along opposing sides of the liftgate 12. The resistive pinch sensors 710 are provided with a separate controller 700 which is in communication with the controller 26 of the capacitive sensing system 10 by way of a LIN communication protocol, or the like.

In FIG. 8, the capacitive sensing system 10 is combined with a pair of resistive pinch sensors 710 disposed along opposing sides of the liftgate 12, as well as a pair of capacitive sensors 810 mounted to the body 16 of the vehicle 12. In a preferred embodiment, the capacitive sensor 810 can be embedded into side trim panels of the body 16 disposed adjacent to the liftgate 12. The resistive pinch sensors 710 and body mounted capacitive sensors 810 are each provided with separate controllers 700, 800 which are in communication with the controller 26 of the capacitive sensing system 10 by way of a LIN communication protocol, or the like.

In FIG. 9, the capacitive sensing system 10 is combined with resistive pinch sensors 710 and liftgate mounted capacitive sensors 910 each extending along opposing sides of the litigate 12. In an embodiment, the resistive pinch sensor 710 and the liftgate mounted capacitive sensor 910 can be incorporated into the same sensor, such as is described in U.S. provisional patent application Ser. No. 61/791,472, incorporated herein by reference. The resistive pinch sensors 710 and capacitive sensors 910 are provided with separate controllers 700, 900 which are in communication with the controller 26 of the capacitive sensing system 10, by way of a LIN communication protocol or the like.

In FIG. 10, the capacitive sensing system 10 is combined with resistive pinch sensors 710 and liftgate mounted capacitive sensors 910. The resistive pinch sensors 710 and capacitive sensors 910 each communicate with the same separate controllers 700 which is in communication with the controller 26 of the capacitive sensing system 10 by way of a LIN communication protocol, or the like. Once again, in an embodiment, the resistive pinch sensor 710 and the liftgate mounted capacitive sensor 910 can be incorporated into the same sensor, such as is described in U.S. provisional patent application Ser. No. 61/791,472, incorporated herein by reference.

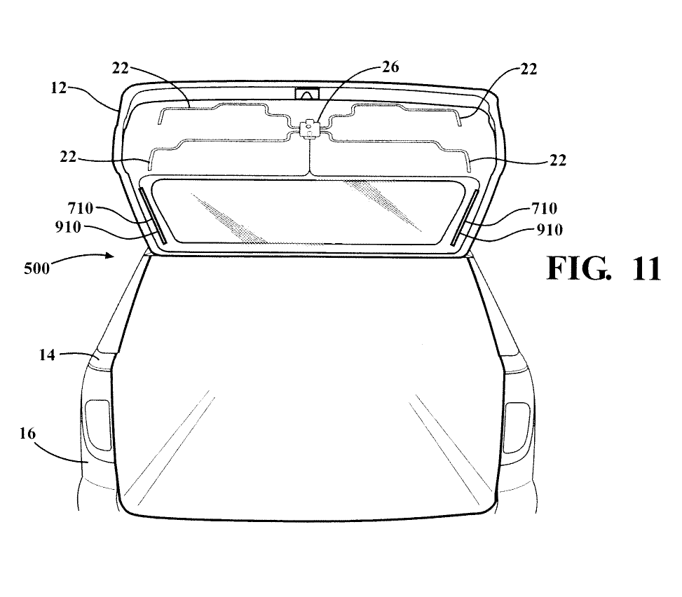

In FIG. 11, the capacitive sensing system 10 is combined with resistive pinch sensors 710 and liftgate mounted capacitive sensors 910. Once again, in an embodiment, the resistive pinch sensor 710 and the liftgate mounted capacitive sensor 910 can be incorporated into the same sensor, such as is described in U.S. provisional patent application Ser. No. 61/791,472, incorporated herein by reference. Also, the resistive pinch sensors 710, capacitive sensors 910, and the at least one elongate capacitive sensor 22 all share a common controller 26. As a result, an integrated and common controller 26 leads to cost savings for the capacitive sensing system 10.

Thus, according to one embodiment, there is provided a capacitive sensing system 10 for a liftgate 12 of a vehicle 14, comprising: at least one elongate capacitive sensor 22 mounted on a trim panel 400 of the liftgate 12, the at least one elongate capacitive sensor 22 arranged to extend over an area 100 of the trim panel 400; and, a controller 26 coupled to the at least one elongate capacitive sensor 22 for monitoring changes in a capacitance value of the at least one elongate capacitive sensor 22, the capacitance value changing when an obstacle approaches the area 100. In the above capacitive sensing system, the at least one elongate capacitive sensor 22 may be a plurality of elongate capacitive sensors 22.

The above embodiments may contribute to an improved capacitive sensing system 10 and may provide one or more advantages. First, by arranging or distributing the capacitive sensors 22 over an area 100 of the trim panel 400 of the liftgate 10 to improve obstacle detection. Second, the capacitive sensing system 10 may be combined with pinch sensing systems to further improve obstacle detection. Third, false positive indications or noise may be reduced by using multiple sensors 22 distributed over an area 100 of the trim panel 400 as the likelihood of an obstacle activating all of the sensors 22 is not large.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A capacitive sensing system for a liftgate of a vehicle, comprising:
at least one elongate capacitive sensor mounted on a trim panel of the liftgate, said at least one elongate capacitive sensor arranged to extend over an area of the liftgate trim panel; and
a controller coupled to said at least one elongate capacitive sensor for monitoring changes in a capacitance value of said at least one elongate capacitive sensor, the capacitance value changing when an obstacle approaches the area.

2. The capacitive sensing system of claim 1, wherein said at least one elongate capacitive sensor includes a plurality of elongate capacitive sensors arranged to extend over a substantial area of the trim panel, each of said plurality of elongated capacitive sensors individually coupled to said controller.

3. The capacitive sensing system of claim 2, wherein said plurality of capacitive sensors includes four elongate capacitive sensors each extending from said controller to a respective corner of the liftgate trim panel.

4. The capacitive sensing system of claim 1, wherein said at least one sensor is mounted in a mounting channel extending along the liftgate trim panel.

5. The capacitive sensing system of claim 4, wherein said mounting channel is attached to the liftgate trim panel.

6. The capacitive sensing system of claim 4, wherein said mounting channel is moulded into the liftgate trim panel.

7. The capacitive sensing system of claim 4, wherein said at least one sensor establishes a compressive fit with said mounting channel.

8. The capacitive sensing system of claim 7, wherein said at least one sensor includes a plurality of compressive ridges extending along outer sides of a case, said compressive ridges disposed in engaging relationship with inner sides of said mounting channel to establish the compressive fit therebetween.

9. The capacitive sensing system of claim 1, further comprising at least one resistive pinch sensor mounted to the liftgate.

10. The capacitive sensing system of claim 9, wherein said at least one resistive pinch sensor is coupled to a second controller separate from but in communication with said controller.

11. The capacitive sensing system of claim 9, further comprising at least one body mounted capacitive sensor mounted to a side trim panel disposed adjacent to the liftgate of the vehicle.

12. The capacitive sensing system of claim 11, wherein said at least one body mounted capacitive sensor is coupled to a third controller separate from but in communication with said controller and said second controller.

13. The capacitive sensing system of claim 9, further comprising at least one litigate mounted capacitive sensor mounted to the liftgate.

14. The capacitive sensing system of claim 13, wherein said at least one liftgate mounted capacitive sensor is coupled to a third controller separate from but in communication with said controller and said second controller.

15. The capacitive sensing system of claim 14, wherein said at least one liftgate mounted capacitive sensor is coupled to said second controller.

16. The capacitive sensing system of claim 13, wherein said comprising at least one resistive pinch sensor and said at least one liftgate mounted capacitive sensor are coupled to said controller.
